(19) United States
(12) Patent Application Publication
(10) Pub. No.: US 2003/0108582 A1
(43) Pub. Date: Jun. 12, 2003

(54) Insect repellent comprising essential volatile oils and use thereof

(76) Inventor: Mark T. Willis, Goetzville, MI (US)

Correspondence Address: Mark T. Willis, 12941 E. Townline Road, Goetzville, MI, 49736, US

(21) Appl. No.: 09/946,427

(22) Filed: Dec. 10, 2001

(51) Int. Cl. A01N 65/00; A01N 25/00

(52) U.S. Cl. 424/405; 424/742; 424/744; 424/745; 424/747; 424/735; 424/757

(57) ABSTRACT

A composition that has insect repellent properties is made from essential volatile oils. The inventive composition includes a combination of menthol, eucalyptus oil, citronella oil and/or tea tree oil, alcohol, water and skin moisturizing components. Menthol in crystal or liquid form. Essential oil of eucalyptus. Essential oil of citronella and/or tea tree oil. Isopropyl alcohol, grain alcohol or any other type of distilled alcohol. Deionized, distilled or any other type of sterile water. Skin conditioning oils including but not limited to mineral oil, jojoba oil, glycerin, Vitamin E. The topical composition can be formulated as a solution, suspension, cream, ointment, gel, film or spray.

### BACKGROUND OF THE INVENTION

1. Field of the Invention

The present invention relates generally to a composition for use in repelling insects and more specifically it relates to a non-toxic insect repellent composition using only naturally occurring insect repellent components.

2. Description of the Prior Art

Insect repellents have been used for centuries to prevent insect pests from bothering and annoying humans and animals. Some examples of known repellents include citronella candles made from the essential oil of citronella. In the past century, synthetic chemicals have been designed and developed that more effectively repel insects. Included in these newer synthetic compounds are 2-ethyl-3-hexanediol, (DDT) and N,N-diethyl toluamide, (DEET).

However, most synthetic chemical compound repellents, when absorbed through the skin or somehow ingested are toxic as in the ban of the insecticide DDT which was shown to be harmful to the environment by poisoning wildlife, and DEET is suspected to be a carcinogen, teratogen and or mutagen. Therefore, some states and federal regulations limit the percentage of DEET to 10% to 30%, which may be used in compositions for children, adults and animals use.

The main problem with synthetic chemical compounds is that insects can develop a genetic resistance to these chemicals. Through natural selection, each generation of insect is more resistant to the synthetic chemical then the generation before. Therefore, stronger concentrations or larger amounts of these synthetic chemicals are needed in each generation to provide the same results. DEET and other synthetic chemicals, particularly known or suspected to have toxic effect carcinogens, teratogensand, mutagens, these larger doses are undesirable because of the possible toxic effects on humans, and animals alike. DEET is also known to have damaging effects on certain plastic products.

It has been known that various naturally occurring substances work as insect repellents in nature. In particular, the essential volatile oils of various plants repel certain insects and are not believed to create genetic mutations in insects. Therefore, no resistance to these natural substances should be developed by insects.

### SUMMARY OF THE INVENTION

In view of the foregoing disadvantages inherent in the known types of insect repellents, now present in the prior art, the present invention provides a insect repellent comprising essential volatile oils wherein the same can be utilized for the repelling of insects using essential volatile oils.

The general purpose of the present invention, which will be described subsequently in greater detail, is to provide a new insect repellent comprising essential volatile oils that has many of the advantages in the repelling of insects mentioned heretofore and many novel features that result in a new insect repellent comprising essential volatile oils which is not anticipated, rendered obvious, suggested, or even implied by any of the prior art for repelling insects, either alone or in any combination thereof.

To attain this, the present invention generally comprises menthol crystals, eucalyptus oil, citronella oil and/or tea tree oil, alcohol, water and skin conditioners. Menthol in crystal or liquid form, Essential oil of eucalyptus. Essential oil of citronella and/or essential oil of tea tree. Isopropyl alcohol, grain alcohol or any other type of distilled alcohol. Deionized, distilled or any other type of sterile water. Skin conditioning oils including but not limited to mineral oil, jojoba oil, glycerin, Aloe Vera,Vitamin E.

There has thus been outlined; rather broadly, the more important features of the invention in order that the detailed description thereof may be better understood, and in order that the present contribution to the description may be better appreciated. There are additional features of the invention that will be described hereinafter.

In this respect, before explaining at least one embodiment of the invention in detail, it is to be understood that the invention is not limited in its application to the details of composition and to the arrangements of the components set forth in the following description. The invention is capable of other embodiments and of being practiced and carried out in various ways. Also, it is to be understood that the phraseology and terminology employed herein are for the purpose of the description and should not be regarded as limiting.

A primary object of the present invention is to provide a insect repellent comprising essential volatile oils, that will overcome the shortcomings of the prior art compositions.

An object of the present invention is to provide a non-toxic environmentally friendly composition to repel insects.

Another object is to provide a natural insect repellent which does not allow insects to develop a genetic resistance.

Another object is to provide a insect repellent with transdermal properties.

Other objects and advantages of the present invention will become obvious to the reader and it is intended that these objects and advantages are within the scope of the present invention.

To the accomplishment of the above and related objects, this invention may be embodied in the form described, and that changes may be made in the specific composition.

### DESCRIPTION OF THE PERFERRED EMBODIMENT

Turning now descriptively to the details of the invention, the attached details illustrate a insect repellent comprising essential volatile oils, which comprises menthol crystals, eucalyptus oil, citronella oil and or tea tree oil, alcohol water and skin conditioners/moisturizers. Menthol in crystal or liquid form. Essential oil of eucalyptus. Essential oil of citronella and or tea tree oil. Isopropyl alcohol, grain alcohol or any other type of distilled alcohol. Deionized, distilled or any other type of sterile water. Skin conditioning ingredients including but not limited to mineral oil, jojoba oil, glycerin, Vitamin E, peppermint oil.

Menthol in crystal or liquid form. Menthol in a crystal form or liquid form is used to allow the essential oil vapors to penetrate transdermally into and through the skin of a human or animal. The menthol component either in dissolved crystal or liquid menthol provides necessary penetration properties.

Essential oil of eucalyptus. Essential oil of eucalyptus which for this composition are used for their known insect repellent properties and known transdermal skin penetrating properties. Essential oil of eucalyptus also has anti-inflammatory and analgesic properties

Essential oil of citronella. Essential oil of citronella in this composition is used for its known insect repellent properties. The volatile vapors of citronella are also known to penetrate into human and animal skin.

Isopropyl alcohol, grain alcohol or any other type of distilled alcohol. The use of alcohol in this composition is to provide a solvent to place composition into solution. This alcohol can be isopropyl but not limited to isopropyl. Distilled grain alcohol, isopropyl alcohol, ester alcohol can be used in this composition along with other types of natural based solvents.

Deionized, distilled or any other type of sterile water. Water in the form or distilled either by steam or osmosis can be used along with deionized and sterile water. The water in this composition is used to control the vaporization of the menthol and essential oils and is also used to dilute the alcohol purity in this composition.

Skin conditioners in this composition are to counteract the drying properties of the alcohol used. These skin conditioners can be a composition consisting one or more of the following known skin moisturizing ingredients: mineral oil, jojoba oil, glycerin, almond oil, aloe vera, lanolin, Vitamin E and peppermint oil.

The use of this topical composition can be formulated as a solution, suspension, cream, ointment, gel, film or spray. This composition for repelling insects is made by, combining alcohol (42.0% to 48.0% by weight), adding menthol crystals (5.0% to 7.0% by weight), eucalyptus oil (0.30% to0.80% by weight), citronella and or tea tree oil (0.10% to 0.25% by weight), and skin conditioner ingredients (0.6% to 0.9% by weight) into a blending unit blend until components become solution, water is then added to this solution (41% to 47% by weight) solution is then combined. Fragrance additives may be blended into this solution to provide a pleasant aroma these can include cinnamon extract, citrus oil, vanilla extract or any natural aromatic fragrance.

As to a further discussion of the matter of usage and operation of the present invention, the same should be apparent from the above description. Accordingly, no further discussion relating to the manner of usage and operation will be provided.

With respect to the above description then, it is to be realized that the optimun composition of the invention, to included variations in size, materials, quantities, form, function and manner of operation, are deemed readily apparent and obvious to one skilled in the art, and all equivalent relationships to those described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact composition and operation shown and described, and accordingly, all suitable modifications and equivalents may be resorted to, falling within the scope of the invention.

I claim:

1. A composition for repelling insects is formulated by: combining alcohol (42.0% to 48.0% by weight), menthol (5.0% to 7.0% by weight), eucalyptus oil (0.30% to 0.80% by weight), citronella oil (0.10% to 0.25% by weight), and skin conditioner ingredients (0.6% to 0.9% by weight) and water (41% to 47% by weight).

2. A composition according to claim 1, wherein the addition of essential oil of tea tree is added to composition 1 by (0.10% to 0.25% by weight)

3. A composition according to claim 1, wherein the skin conditioners consist of one or more ingredients chosen from the following group, mineral oil, vitamin E oil, peppermint oil, glycerin, aloe vera plant extract, jojoba oil, or almond oil.

4. A composition according to claim 1, wherein menthol component to be in crystal or liquid form.

5. A composition according to claim 1, wherein a fragrance component is added from the following group but not limited to this fragrance group: cinnamon extract, citrus oil, vanilla extract or any natural aromatic fragrance component.

6. A composition according to claim 1, wherein the use of a natural thickening agent is used to increase the viscosity of composition so it may be applied using a roll-on method.

7. A composition according to claim 1, where in the water component is any type of distilled water, mineral water or tap water.

8. A composition according to claim 1, wherein the composition is applied by a mist of spray from a pump type or pressure type of application.
